(19) United States
(12) Patent Application Publication
(10) Pub. No.: US 2026/0370338 A1
(43) Pub. Date: Nov. 19, 2026

(54) RECEIVER AND METHOD FOR DECODING STRUCTURED OPTICAL SIGNALS USING REGION-OF-INTEREST SPATIAL INTENSITY DETECTION

(71) Applicant: Eliyah Omar El-Moreh, Kelowna (CA)

(72) Inventor: Eliyah Omar El-Moreh, Kelowna (CA)

(21) Appl. No.: 19/700,224

(22) Filed: Jun. 6, 2026

(30) Foreign Application Priority Data
May 15, 2025 (CA) 3273914
Mar. 19, 2026 (CA) 3305435
Apr. 3, 2026 (CA) 3307267

(51) Int. Cl. H04B 10/54; H04B 10/564

(52) U.S. Cl. CPC H04B 10/54; H04B 10/564

(57) ABSTRACT

A method, receiver, and computer-readable medium recover information encoded in a structured optical pattern by detecting spatial redistribution of intensity rather than total received optical power. An optical detector receives the structured optical pattern, in some embodiments an interference pattern produced by spiral-phase modulation of coherent radiation, and generates spatial intensity data. A plurality of fixed regions of interest at different locations are sampled to derive respective region intensity measures forming a spatial response vector. Candidate regions may be selected using a noise-normalized between-state separation criterion together with a detector-noise-floor criterion. The region intensity measures may be normalized or combined as differential measures to reduce common-mode variation. The spatial response vector is mapped to an encoded symbol while total integrated intensity remains substantially unchanged between encoded states. In some embodiments symbol recovery does not require determining an orbital-angular-momentum mode index or topological charge, enabling segmented-detector implementations without full-image reconstruction.

### TECHNICAL FIELD

The present invention relates to optical signal detection and to the recovery of information encoded in structured optical fields. More particularly, it relates to receiver-side methods, apparatus, and computer-readable media that recover encoded information from the spatial redistribution of intensity within a structured optical pattern, including a structured optical interference pattern produced by spiral-phase modulation, using a plurality of fixed regions of interest.

### BACKGROUND

Optical communication systems conventionally encode information using amplitude, phase, frequency, polarization, or combinations thereof. Spatial-mode techniques extend these approaches by treating the transverse structure of an optical field as an additional degree of freedom, including fields carrying orbital angular momentum or vortex phase structure.

A conventional optical detector reduces much of a received field to a single total-power value. Where information is carried in the transverse spatial structure of the field rather than in its total power, such a detector discards the relevant information. In particular, a structured optical field may be configured such that its total integrated intensity remains substantially constant between distinct states while the spatial distribution of intensity within the field changes significantly. A receiver that measures only total power, or that averages intensity over the full field, is substantially insensitive to such states.

Imaging receivers that reconstruct a full two-dimensional field can in principle capture spatial structure, but full-image reconstruction is costly in detector complexity, data rate, and processing, and is unnecessary where the discriminating information is localized to a limited number of regions of the field.

There is therefore a need for a receiver-side detection technique that recovers information from the spatial redistribution of intensity within a structured optical pattern, that identifies and validates which spatial regions carry discriminating information, that is robust to common-mode fluctuations such as source-power drift and detector-exposure variation, and that can be implemented without full-image reconstruction, including by means of a small number of fixed detector regions or detector segments.

### SUMMARY

In one aspect, a method recovers information encoded in a structured optical pattern. An optical detector receives a structured optical pattern having a total integrated intensity and a spatial intensity distribution. The spatial intensity distribution is sampled at a plurality of fixed regions of interest, each region subtending a sub-portion of the pattern smaller than its full area and at least two of the regions being disposed at different locations within the distribution. A respective region intensity measure is derived for each region, a spatial response vector is formed from the region intensity measures, and the spatial response vector is mapped to an encoded information symbol selected from a set of two or more encoded states. The encoded information symbol is recovered from a spatial redistribution of intensity among the regions that occurs between the encoded states while the total integrated intensity remains substantially unchanged between those encoded states.

In some embodiments the structured optical pattern is an interference pattern produced by spiral-phase modulation of coherent electromagnetic radiation in an interferometric optical system. The spiral-phase modulation may be produced by a vortex lens, a spiral phase plate, a vortex phase mask, a diffractive optical element, a metasurface, a spatial light modulator, or an integrated photonic phase structure, among others.

In some embodiments a region of interest is selected or validated using a noise-normalized between-state separation criterion, determined over a plurality of repeated acquisitions per encoded state, together with a detector-noise-floor criterion, such that a region is used only when its between-state variation is large relative to its within-state variation and its absolute signal exceeds a detector noise floor by a predetermined margin.

In some embodiments the region intensity measures are normalized as fractional region values, or are combined as one or more differential measures between regions, so as to reduce common-mode variation arising from source-power drift, detector-exposure variation, or optical alignment drift. In some embodiments the spatial response vector is mapped to a symbol by classification against reference vectors determined from a calibration acquisition. In some embodiments the receiver is implemented using a camera, a segmented photodetector, or a quadrant photodetector, and recovers the symbol without reconstructing a full two-dimensional image of the pattern.

Further aspects provide a receiver comprising an optical detector, a region-sampling unit, and a processing unit configured to perform the foregoing, and a non-transitory computer-readable medium storing instructions that cause a processor to perform the foregoing.

Conventional orbital-angular-momentum (OAM) communication systems commonly use helical phase modes as orthogonal spatial channels or mode indices, and data may be carried by conventional amplitude, phase, or quadrature modulation formats applied to beams assigned to those modes, or by switching among OAM mode states, with the receiver performing mode demultiplexing, mode decomposition, conversion of an OAM mode to a Gaussian beam, or determination of a topological charge. In contrast, and as compared schematically in FIG. 12, embodiments of the present invention do not require recovery of a pure OAM mode or determination of a topological charge. Instead, information is recovered from a spatial redistribution of intensity within a spiral-geometric or interferometric pattern: a plurality of fixed regions of interest are selected or validated based on a noise-normalized between-state separation criterion and a detector-noise-floor criterion, and a spatial response vector formed from those regions is mapped to an encoded symbol while the total integrated intensity remains substantially unchanged between encoded states. The measurable state dependence in such embodiments may arise from the combined effects of the spiral-phase modulation, alignment, and interferometric geometry, and need not correspond to a pure cylindrically symmetric OAM mode.

### BRIEF DESCRIPTION OF THE DRAWINGS

FIG. 1 is a schematic block diagram of a system for encoding information in a structured optical pattern and recovering it at a region-of-interest receiver, according to an embodiment.

FIG. 2 is a schematic diagram of an interferometric optical system that produces a structured optical interference pattern by spiral-phase modulation, according to an embodiment.

FIG. 3 is a schematic illustration of a plurality of fixed regions of interest disposed at different locations within a structured optical pattern.

FIG. 4 is a diagram illustrating the dependence of region sensitivity on region width relative to displacement of an intensity feature between encoded states.

FIG. 5 is a flowchart of a method of recovering an encoded information symbol from a spatial response vector, according to an embodiment.

FIG. 6 is a flowchart of a region selection and validation process using a between-state separation criterion and a detector-noise-floor criterion.

FIG. 7 is a schematic illustration of a segmented or quadrant detector in which each detector segment corresponds to a fixed region of interest.

FIG. 8 is a schematic illustration of a normalized differential readout combining a region of increasing intensity and a region of decreasing intensity between two encoded states.

FIG. 9 is a flowchart of a calibration and decoding workflow in which reference vectors determined from calibration frames are fixed in advance and used to decode received symbol frames by per-frame nearest-reference assignment followed by a per-symbol majority vote.

FIG. 10 is a schematic illustration of a fractional normalization of the region intensity measures to form a normalized spatial response vector.

FIG. 11 is a schematic illustration of fixed regions of interest positioned relative to spiral-geometric reference features of a spiral-geometric intensity distribution, including a vortex core or spiral center, a curved fringe boundary, a phase-singularity location, angular wedge sectors, and annular or radial sectors.

FIG. 12 is a schematic comparison of a conventional orbital-angular-momentum receiver, which recovers a symbol by mode demultiplexing or mode decomposition, with a receiver according to an embodiment, which recovers a symbol from a spatial response vector formed from fixed validated regions of interest without requiring determination of an orbital-angular-momentum mode index or topological charge.

### DETAILED DESCRIPTION

The following description sets forth numerous specific details by way of example and not limitation. It will be apparent to a person skilled in the art that the invention may be practiced without some of these specific details and that various modifications and equivalents fall within the scope of the claims. Section headings are provided for convenience and do not limit the disclosure. As used herein, the terms “comprising” and “including” are open-ended; “approximately” and “substantially” account for ordinary measurement and manufacturing tolerances; and “or” is inclusive unless otherwise indicated.

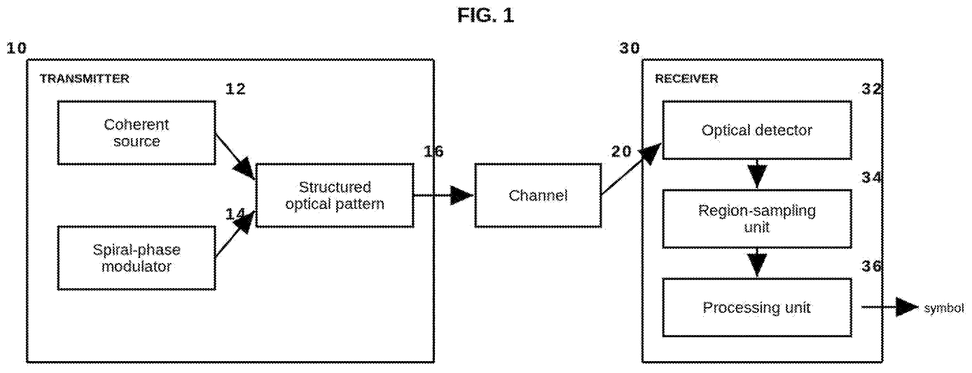

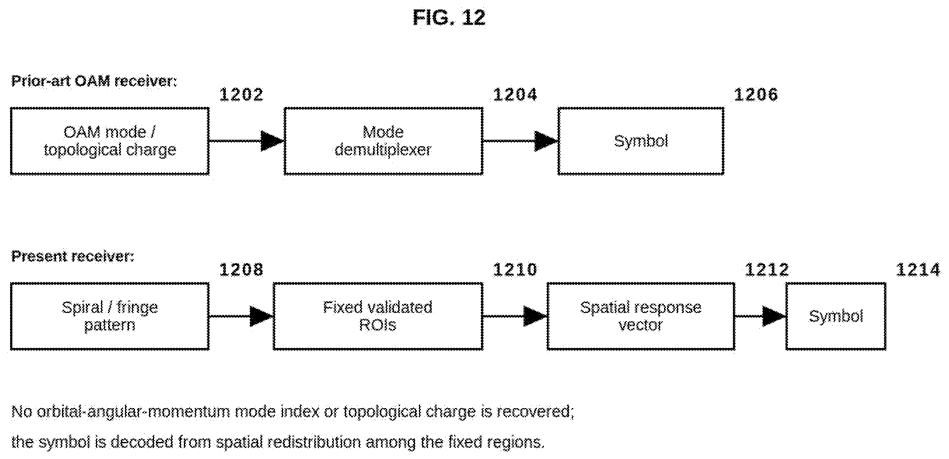

The invention is described with reference to the accompanying drawings, FIG. 1 through FIG. 12, in which like reference numerals denote like elements throughout. The reference numerals introduced below correspond to the elements shown in the drawings.

### Structured Optical Pattern and Overall System

Referring to FIG. 1, a system comprises a source of a structured optical pattern (within a transmitter 10) and a receiver 30. A structured optical pattern (16), as used herein, is an optical field having a spatial intensity distribution that varies across a detection plane and that can be configured into two or more distinguishable encoded states. The structured optical pattern has a total integrated intensity, being the intensity integrated over substantially the full area of the pattern at the detection plane, and a spatial intensity distribution, being the distribution of intensity among sub-portions of that area. In the embodiment of FIG. 1, the transmitter 10 comprises a coherent source 12 and a spiral-phase modulator 14 that together produce the structured optical pattern 16, which propagates over a channel 20 to the receiver 30. The receiver 30 comprises an optical detector 32, a region-sampling unit 34, and a processing unit 36.

A defining property exploited by the receiver is that the encoded states differ from one another principally in the spatial distribution of intensity, while the total integrated intensity remains substantially unchanged between the encoded states. Accordingly, a receiver measuring only total integrated intensity is substantially unable to distinguish the encoded states, whereas a receiver sensitive to the spatial redistribution of intensity can distinguish them.

As used herein, the total integrated intensity remaining “substantially unchanged” between encoded states includes, in various embodiments, cases in which the total integrated intensity varies between the encoded states by less than a threshold amount, such as less than approximately ten percent, less than approximately five percent, less than approximately two percent, or less than approximately one percent, while at least one region intensity measure of at least one fixed region of interest varies between the same encoded states by a larger amount, such as by at least approximately five percent, at least approximately eight percent, or at least approximately ten percent. These ranges are examples and not limitations; the relevant condition is that a localized region intensity measure varies between encoded states by a greater proportion than the total integrated intensity varies between those states, such that the encoded states are more readily distinguished from the spatial intensity distribution than from the total integrated intensity.

The structured optical pattern is not limited to any particular means of generation. In some embodiments it is a structured optical interference pattern produced by an interferometric optical system; in other embodiments it is produced by a diffractive, holographic, programmable, or metasurface element without an interferometric recombination; the receiver-side techniques described herein are applicable to any structured optical pattern exhibiting the spatial-redistribution property described above.

### Interferometric Embodiment

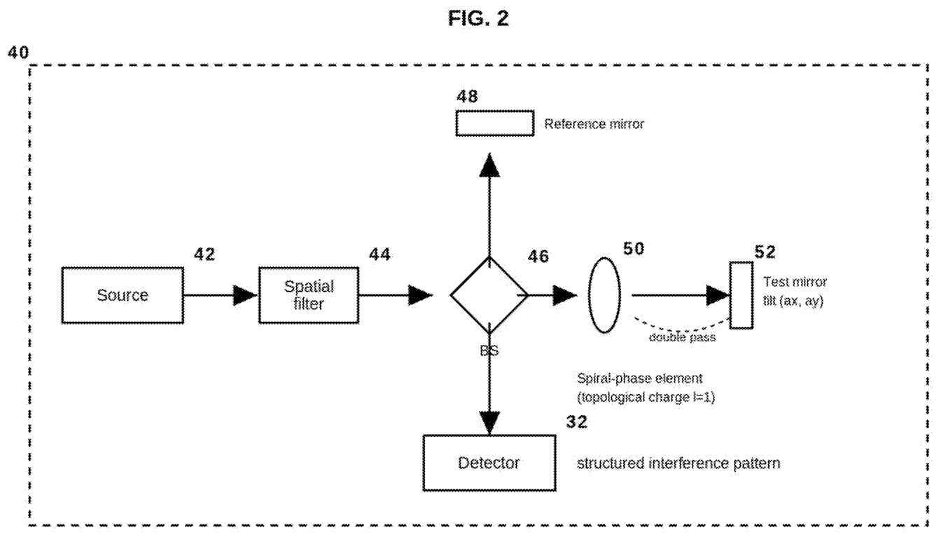

Referring to FIG. 2, in one embodiment the structured optical pattern is an interference pattern produced by spiral-phase modulation of coherent electromagnetic radiation. A coherent source 42 provides radiation that, in this embodiment, is conditioned by a spatial filter 44 and divided by a propagation-control structure such as a beam splitter 46 into at least a first propagation path and a second propagation path. A spiral-phase optical element 50 is positioned within at least one path and introduces a spiral phase into the radiation traveling along that path; a reference mirror 48 terminates the reference path and a test mirror 52 terminates the test path. The radiation from the paths is recombined so as to interfere, producing a structured optical interference pattern that is imaged at a detector 32, the pattern having a spatial topology that depends at least in part on the spiral-phase modulation.

The spiral-phase optical element 50 may comprise one or more of a vortex lens, a spiral phase plate, a vortex phase mask, a diffractive optical element, a metasurface, a holographic optical element, a spatial light modulator, an integrated photonic phase structure, a programmable phase array, a waveguide phase structure, or another wavefront-shaping element. The vortex lens is described as one embodiment because it was used in the example below, but it is not the boundary of the invention; any element capable of generating the spiral-geometric or structured optical pattern may be used. The spiral phase may be characterized by a topological charge. In some embodiments the spiral-phase element is traversed more than once, for example in a reflective interferometric geometry in which radiation passes through the element on an outgoing pass and again on a returning pass, so that the spiral phase is imposed more than once per round trip. The coherent radiation is not limited to visible light and may, in other embodiments, comprise infrared, ultraviolet, microwave, radio-frequency, or terahertz radiation.

FIG. 2 illustrates one reflective interferometric embodiment. The receiver-side region-of-interest detection techniques described herein are not limited to a Michelson interferometer and may be used with a Mach-Zehnder, Sagnac, common-path, integrated photonic, free-space, or fiber-based interferometer, or with a diffractive, holographic, metasurface, or other non-interferometric structured-pattern generator. The interferometric arrangement of FIG. 2 is therefore an example of a means of generating the structured optical pattern and does not limit the receiver-side techniques to any particular generation mechanism.

Encoded states may be defined by adjusting the spiral-phase modulation, for example by rotating the spiral-phase optical element among a plurality of orientations, by electronically programming a phase element, or by otherwise varying the imposed spiral phase. In some embodiments an additional control varies a transverse phase gradient of the interferometric system, for example by adjusting a tilt of a mirror in one path, so as to steer a position of an intensity feature of the pattern across the detection plane. The encoded state may then be associated jointly with the spiral-phase modulation and with the position of the intensity feature, providing a larger set of encoded states than spiral-phase variation alone.

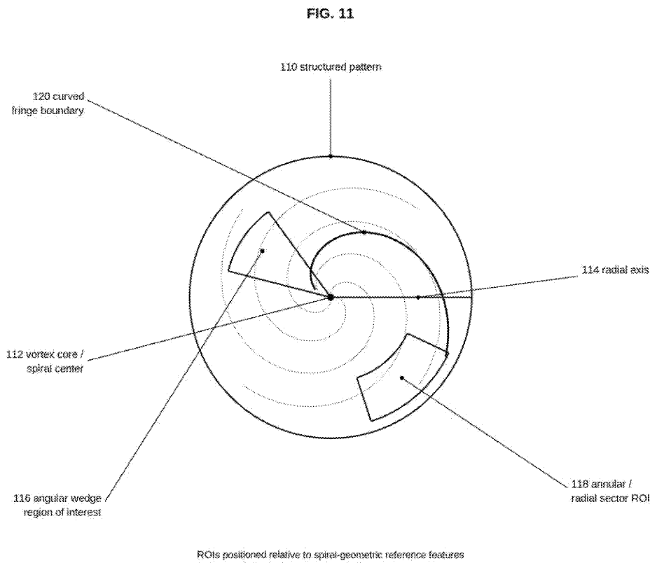

Referring to FIG. 11, in spiral-geometric embodiments the fixed regions of interest are positioned relative to spiral-geometric reference features of the pattern 110 rather than as arbitrary rectangular sub-areas. Such reference features include a vortex core or spiral center 112, a radial axis 114, and a curved fringe boundary 120. The fixed regions of interest may comprise angular wedge sectors 116 arranged about the spiral center, and annular or radial sectors 118 defined at successive radii from the spiral center. Positioning the regions relative to the spiral-geometric reference features aligns each region with the portion of the spiral-geometric intensity distribution that redistributes most strongly between encoded states, and distinguishes the present region sampling from sampling at arbitrary fixed rectangular locations.

### Fixed Regions of Interest and the Spatial Response Vector

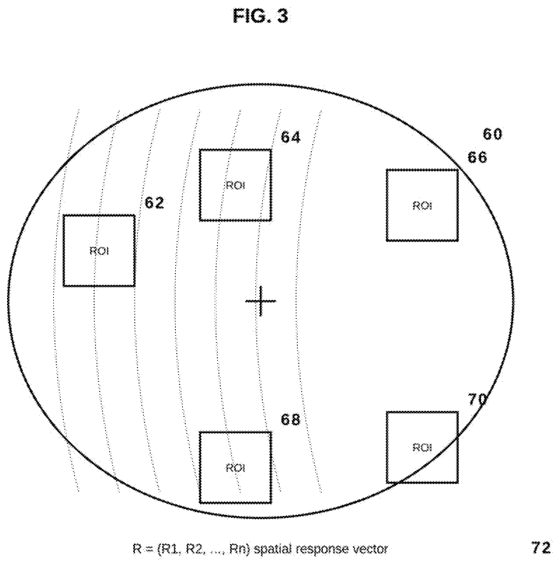

Referring to FIG. 3, the receiver samples the spatial intensity distribution of the structured optical pattern 60 at a plurality of fixed regions of interest 62, 64, 66, 68, 70. Each region of interest subtends a sub-portion of the structured optical pattern smaller than the full area of the pattern, and at least two of the regions are disposed at different locations within the spatial intensity distribution. A region of interest may correspond to a digitally defined sub-area of image data captured by an imaging detector, or to a physical segment of a segmented or quadrant detector, as described below.

A region of interest is fixed in the sense that it occupies the same location across the encoded states being recovered, so that it functions as a stationary detector window measuring local changes in the spatial intensity distribution as the encoded state changes. For each region, a respective region intensity measure is derived. The region intensity measure may be a sum of pixel intensities within the region, a mean intensity over the region, an integrated intensity, or another measure monotonically related thereto. Where the regions have equal area, a mean intensity is sufficient; where the regions have unequal area, a normalized or area-weighted measure may be used.

The term “fixed” as applied to a region of interest encompasses two cases. In some embodiments a region of interest is fixed relative to the detector plane, occupying the same pixel or detector-segment location in every frame and for every encoded state. In other embodiments a region of interest is fixed relative to a reference feature of the structured optical pattern—for example a spiral-geometric reference feature, a vortex core, a phase-singularity location, a spiral center, or a fringe boundary, or a tracked intensity feature—such that the region may move or be updated in detector coordinates between frames while remaining registered to the same feature of the pattern. A region of interest may therefore be a detector-fixed region, a pattern-registered region, a tracked or moving region following a displacement of an intensity feature, or an adaptively updated region, provided that it is sampled consistently with respect to its reference so that the region intensity measures remain comparable across encoded states. The region-selection and validation criteria described herein apply to detector-fixed, pattern-registered, tracked, and adaptive regions alike.

A spatial response vector 72 is formed from the respective region intensity measures of the plurality of regions, for example R=(R₁, R₂, . . . , Rₙ) for n regions. The spatial response vector represents the state of the pattern by where intensity is distributed among the regions rather than by total received power. Because the encoded states are distinguished by spatial redistribution while total power is substantially unchanged, the spatial response vector carries discriminating information that a total-power measurement does not.

### Region Sensitivity and Region Width

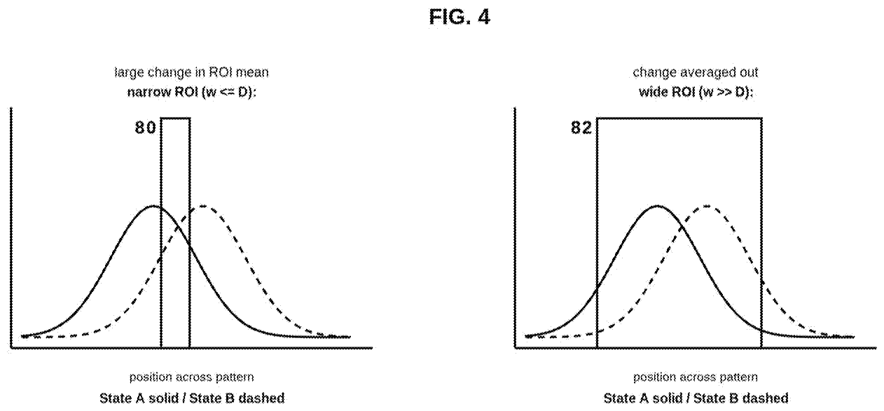

Referring to FIG. 4, the sensitivity of a region of interest to a change of encoded state depends on the width of the region relative to the displacement of an intensity feature of the pattern between states. Where an intensity feature, such as a bright or dark band, shifts by a displacement between two states, a region whose width is comparable to or smaller than the displacement registers a large change in its region intensity measure, because the feature moves substantially into or out of the region. A region whose width is large relative to the displacement averages the same shift over a larger area and registers a small change. Accordingly, in some embodiments at least one region of interest has a width selected to be comparable to or smaller than the displacement of an intensity feature between encoded states, so that movement of the feature produces a change in the region intensity measure greater than the change produced, by the same movement, in a region whose width is large relative to the displacement.

### Region Selection and Validation

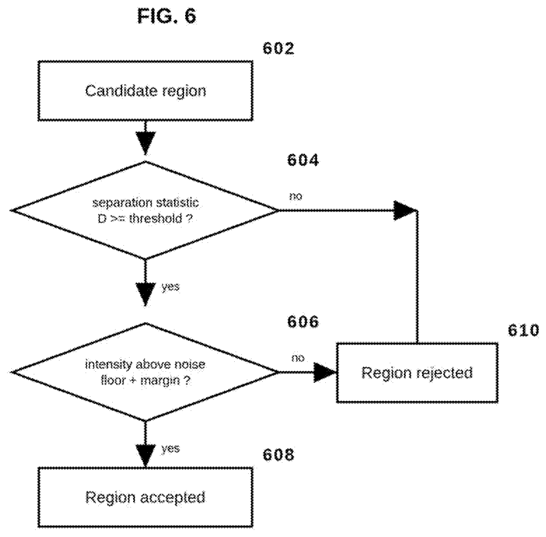

Referring to FIG. 6, regions of interest may be selected or validated according to two criteria applied together, so that a region is used only when it both changes strongly relative to its own noise and carries sufficient absolute signal.

Under a first criterion, a noise-normalized between-state separation statistic is determined for a candidate region over a plurality of repeated acquisitions per encoded state. For each encoded state, a plurality of acquisitions of the region intensity measure are obtained while the encoded state is held fixed, yielding a per-state mean and a per-state within-state variation, such as a standard deviation. The separation statistic compares a spread of the per-state means to the within-state variation. In one form, the separation statistic D is a difference between the largest and smallest per-state mean divided by a pooled within-state standard deviation across the states, for example D=(maxₙ μₙ−min ₙ μₙ)/√((1/N)Σₙσₙ²). A region is selected or validated only when D exceeds a predetermined threshold; in some embodiments the threshold is at least approximately three. A value of the separation statistic near unity indicates that apparent between-state variation is comparable to noise, and the region is not used.

Under a second criterion, a candidate region is rejected when an average intensity of the region does not exceed a detector dark-signal level by a predetermined margin. In some embodiments the average region intensity must exceed the detector dark-signal level by at least approximately five times a standard deviation of the detector dark-signal. This second criterion excludes regions that exhibit a high between-state percentage variation merely because their absolute intensity is low, near the detector noise floor.

In some embodiments a candidate region of interest is selected or validated only when both criteria are satisfied: the noise-normalized between-state separation statistic exceeds a predetermined separation threshold, and the average region intensity exceeds a detector noise floor by a predetermined margin. Applying both criteria converts region selection from a visual or ad hoc choice into a reproducible procedure that is not biased toward regions that merely happen to exhibit large percentage variation.

The purpose of region selection in these embodiments is to maximize the measured separability of a communication-symbol alphabet among the encoded states, so that the selected regions best distinguish one encoded state from another. This differs in purpose from region or feature selection in other fields: the regions are not selected in order to reconstruct an optical wavefront, to estimate a physical surface profile or depth, to measure a topological charge of a beam, or to demultiplex an orbital-angular-momentum mode. A region that is highly informative for one of those other purposes is not necessarily selected here, and a region selected here is chosen for its contribution to symbol separability under the validation criteria described above.

In some embodiments every fixed region of interest of the plurality is selected or validated by both the separation and noise-floor criteria. In other embodiments a subset of the fixed regions of interest is selected or validated by both criteria while one or more further regions are used as auxiliary regions, for example regions that contribute additional spatial information without independently satisfying both criteria. The spatial response vector may therefore be formed from validated regions alone or from a combination of validated regions and auxiliary regions.

### Complementary Regions

Different regions of the pattern respond differently to changes of encoded state, so that a region that does not separate a given pair of states may be separated by another region. In some embodiments the plurality of regions comprises a first region that distinguishes a first pair of encoded states more strongly than a second pair, and a second region that distinguishes the second pair more strongly than the first pair. The spatial response vector formed from both regions thereby resolves a pair of encoded states that is not resolved by either region alone. Combining a plurality of regions as a feature vector accordingly improves discrimination beyond that achievable by any single region, and regions carrying complementary information may be combined even where some individual regions are weak discriminators.

### Normalization and Differential Measures

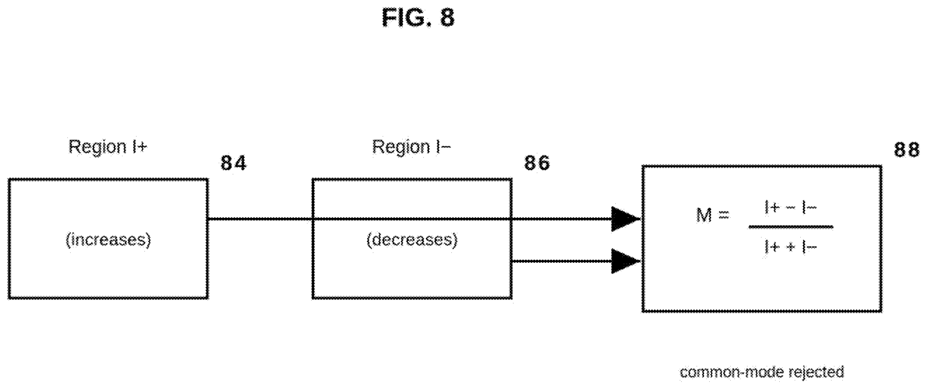

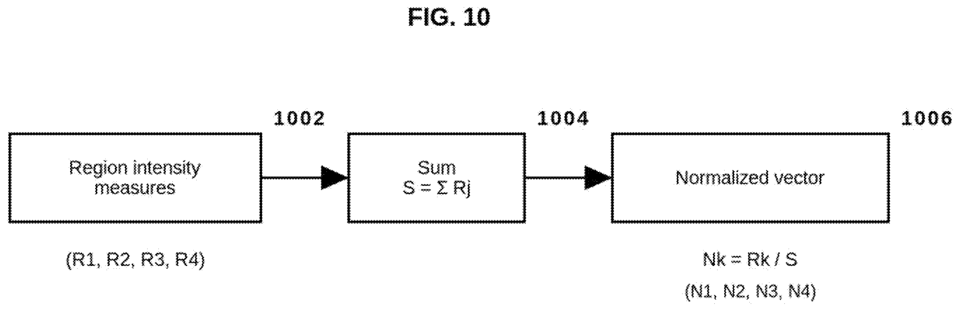

Referring to FIG. 8 and FIG. 10, in some embodiments the region intensity measures are processed to reduce common-mode variation arising from source-power drift, detector-exposure variation, or optical alignment drift. In one form, illustrated in FIG. 10, the region intensity measures 1002 are summed 1004 and normalized as fractional region values 1006, each normalized value being a ratio of a corresponding region intensity measure to a sum of the region intensity measures of the plurality of regions, for example Nₖ=Rₖ/Σⱼ Rⱼ. The normalized spatial response vector encodes a relative spatial distribution substantially independent of overall received power.

In another form, a differential spatial measure is computed between a first region whose region intensity measure increases between two encoded states and a second region whose region intensity measure decreases between the same two states, the differential measure being normalized by a sum of the two region intensity measures, for example M=(I₊−I₋)/(I₊+I₋) . Such a normalized differential rejects common-mode fluctuations affecting both regions. In some embodiments the differential measures comprise one or more of a left-right differential, a top-bottom differential, and a diagonal differential computed from four subregions of the pattern, for example from four quadrant subregions I_TL, I_TR, I_BL, I_BR. The differential measures may be included as components of the spatial response vector.

### Mapping the Response Vector to a Symbol

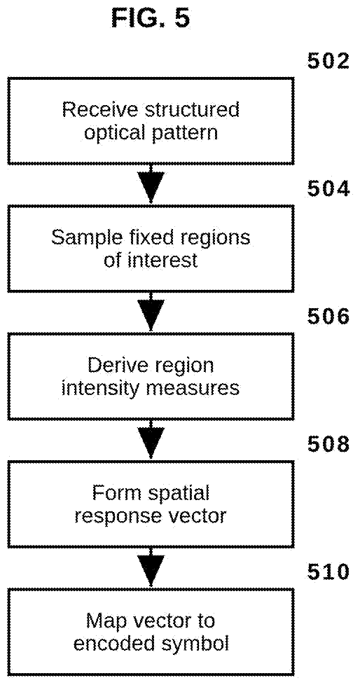

Referring to FIG. 5, the spatial response vector is mapped to an encoded information symbol. Mapping may comprise assigning the spatial response vector to a nearest one of a plurality of reference vectors, each reference vector corresponding to a respective encoded state. In some embodiments the components of the spatial response vector are standardized prior to a distance-based assignment, so that a region of higher absolute intensity does not dominate the distance, for example by z-scoring each component. Mapping may employ thresholding, template matching, nearest-centroid classification, statistical classification, machine-learning classification, or neural-network classification.

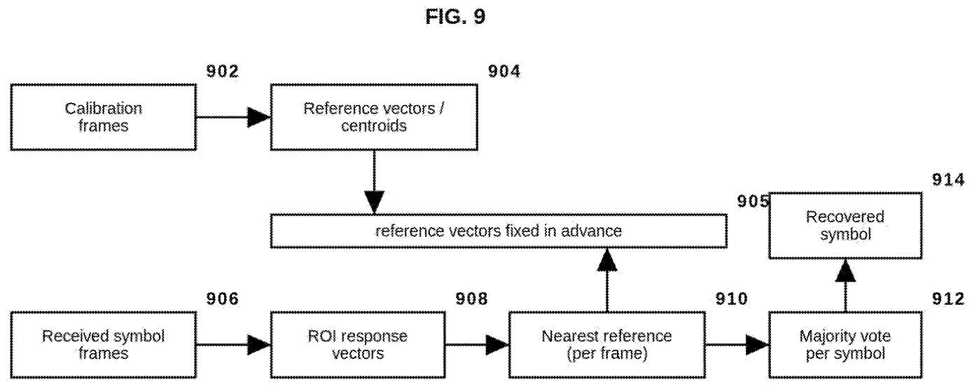

Referring to FIG. 9, in some embodiments the reference vectors 904 are determined from a calibration acquisition (calibration frames 902) that is separate from a transmitted sequence of encoded symbols, and the reference vectors are fixed in advance of acquisition of the transmitted sequence (905). Received symbol frames 906 are converted to ROI response vectors 908, each assigned to a nearest reference vector on a per-frame basis 910. A plurality of frames may be acquired for each transmitted symbol, each frame mapped individually, and the symbol determined by a majority decision 912 over the per-frame mappings to yield a recovered symbol 914, thereby improving robustness to per-frame noise. In some embodiments a transmitted sequence of encoded symbols is committed prior to acquisition and recovered using reference vectors fixed in advance of acquisition, providing a recovery of a pre-committed symbol sequence not used to define the reference vectors. In some embodiments feedback indicative of an estimation error is provided to a transmitter to adjust subsequent encoded states so as to maintain a calibrated mapping in the presence of channel-induced distortion, thermal drift, or alignment error.

### Detector Implementations

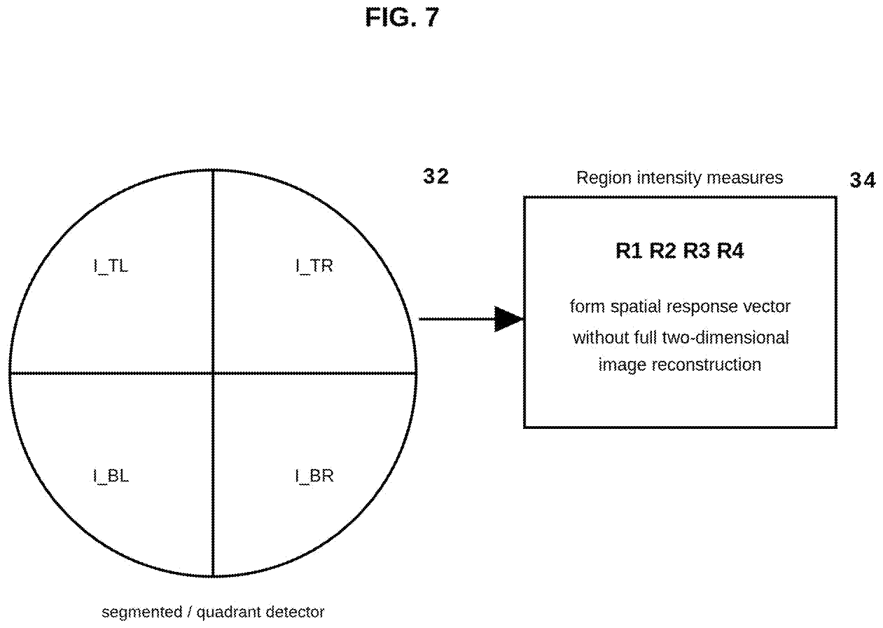

Referring to FIG. 7, the optical detector may comprise a camera, a CMOS image sensor, a CCD image sensor, a quadrant photodetector, a segmented photodetector, a photodiode array, a detector array, or an integrated photonic detector. Where the detector is an imaging detector, each region of interest may correspond to a digitally defined sub-area of the captured image data. Where the detector is a segmented or quadrant detector, each region of interest may correspond to a physical segment of the detector, and the region intensity measures are obtained directly from the segment outputs. In segmented and quadrant implementations the spatial response vector is formed without reconstructing a full two-dimensional image of the pattern, reducing detector complexity, data rate, and processing relative to a full-image-reconstruction receiver.

FIG. 7 illustrates a four-segment detector embodiment. The number, shape, and arrangement of the regions of interest are not limited to four quadrants and may include any plurality of digitally defined or physically segmented regions, including rectangular regions, angular wedge sectors, annular sectors, radial sectors, detector pixels, detector segments, or irregular regions, selected or validated according to the region-selection criteria described herein. The four-quadrant arrangement of FIG. 7 is therefore an example, and the spiral-reference and sector arrangements of FIG. 11 are further non-limiting examples of region geometries usable by the receiver.

In some embodiments, the regions of interest comprise spatiotemporal regions of interest extending over both spatial position and time. For example, a region of interest may correspond to a fixed spatial region sampled over a plurality of frames, a moving or tracked region following a displacement of an intensity feature, a time window, a frame sequence, a depth-resolved region, a volumetric region, or a spatiotemporal volume. The spatial response vector may accordingly comprise, in addition to or instead of static region intensity measures, normalized measures, differential measures, motion measures, temporal derivatives, trajectory features, or frame-to-frame change measures derived from the structured optical pattern. In such embodiments the receiver may recover an encoded information symbol from a spatial redistribution, a temporal evolution, a motion, a rotation, a curvature change, or a spatiotemporal trajectory of the structured optical pattern, in each case without reconstructing a full two-dimensional image, a full three-dimensional optical field, or a full four-dimensional spatiotemporal field. The acquisition of a plurality of frames per symbol and the majority decision described above are one example of using temporal information; the spatiotemporal embodiments described here generalize that use of time, and are distinct from the single-plane, fixed-region example given below, which does not itself perform motion or volumetric decoding.

The receiver comprises a region-sampling unit configured to sample the spatial intensity data at the plurality of fixed regions and to derive the region intensity measures, and a processing unit configured to form the spatial response vector and map it to an encoded information symbol. The region-sampling unit and processing unit may be implemented in dedicated circuitry, in a programmable processor executing stored instructions, in a photonic integrated circuit, or in a combination thereof.

The receiver may be embodied in a variety of practical forms. In some embodiments the region-sampling unit and processing unit are implemented in a field-programmable gate array or a digital signal processor providing real-time region sampling and symbol decoding. In some embodiments the receiver is embodied as a telecommunications optical receiver module, a fiber-coupled detector package, a free-space optical receiver, or an integrated photonic receiver. In some embodiments the receiver comprises a CMOS image sensor together with an embedded processor that defines the fixed regions of interest digitally and computes the spatial response vector on-sensor or in an attached processor. In some embodiments the receiver comprises a segmented or quadrant photodiode together with an analog front-end that derives the region intensity measures from the segment photocurrents, optionally computing one or more differential spatial measures in analog form prior to digitization. These embodiments are examples; the receiver is not limited to any particular hardware realization, and image-based region sampling using general image-analysis tools is one example of region sampling and not a limitation of the claimed receiver.

### Reference Numerals

For convenience, the reference numerals used in the drawings are: 10 transmitter; 12 coherent source; 14 spiral-phase modulator; 16 structured optical pattern; 20 channel; 30 receiver; 32 optical detector; 34 region-sampling unit; 36 processing unit; 40 enclosure; 42 source; 44 spatial filter; 46 beam splitter; 48 reference mirror; 50 spiral-phase optical element; 52 test mirror; 60 structured optical pattern at the detection plane; 62, 64, 66, 68, 70 fixed regions of interest; 72 spatial response vector; 80 narrow region of interest; 82 wide region of interest; 502-510 method steps of receiving, sampling, deriving, forming, and mapping; 602 candidate region, 604 separation-statistic test, 606 noise-floor test, 608 region accepted, 610 region rejected; 84 region of increasing intensity, 86 region of decreasing intensity, 88 differential measure; 902 calibration frames, 904 reference vectors, 905 reference vectors fixed in advance, 906 received symbol frames, 908 ROI response vectors, 910 per-frame nearest-reference assignment, 912 majority vote, 914 recovered symbol; 1002 region intensity measures, 1004 sum, 1006 normalized spatial response vector; 110 spiral-geometric pattern at the detection plane, 112 vortex core or spiral center, 114 radial axis, 116 angular wedge region of interest, 118 annular or radial sector region of interest, 120 curved fringe boundary; 1202 OAM mode or topological charge, 1204 mode demultiplexer or mode decomposition, 1206 symbol recovered by a conventional OAM receiver, 1208 spiral or fringe pattern, 1210 fixed validated regions of interest, 1212 spatial response vector, 1214 symbol recovered according to an embodiment. These numerals are provided for convenience and do not limit the claims.

### Computer-Readable Medium and General Remarks

A non-transitory computer-readable medium may store instructions that, when executed by a processor, cause the processor to receive spatial intensity data representing a structured optical pattern, sample the data at a plurality of fixed regions, derive region intensity measures, form a spatial response vector, select or validate at least one region using both the between-state separation criterion and the detector-noise-floor criterion, and map the spatial response vector to an encoded information symbol recovered from spatial redistribution while total integrated intensity remains substantially unchanged between encoded states.

The embodiments described above are examples. Features described with respect to one embodiment may be combined with features of another. The numerical thresholds given, including the separation threshold of approximately three and the noise-floor margin of approximately five standard deviations, are examples and other values may be used. The scope of protection is defined by the claims, and equivalents thereof, and is not limited to the described embodiments.

Example 1—Three-State ROI Receiver Demonstration

The following non-limiting example illustrates one reduction of the foregoing to practice. A structured optical interference pattern was produced using a continuous-wave laser at approximately 532 nm in a free-space interferometric arrangement having a reference arm and a test arm, the test arm containing a spiral-phase optical element of topological charge one through which the test-arm radiation passed twice per round trip. Three encoded states were defined by setting the spiral-phase element to three orientations, denoted CCW, Centre, and CW. The recombined pattern was imaged at a detection plane, and region intensity measures were derived from fixed regions of interest defined on the captured images.

The CCW, Centre, and CW states are illustrative experimental states and do not limit the encoded symbol alphabet. In other embodiments, the encoded states may comprise any two or more distinguishable spatial, spiral-geometric, interferometric, temporal, or spatiotemporal states that produce different region intensity measures among the fixed regions of interest. By way of non-limiting example, the encoded states may correspond to different spiral-phase or vortex orientations, different phase-singularity positions, different spiral-fringe curvatures, different azimuthal-sector intensity distributions, different spiral pitch, pitch-to-radius ratio, or handedness, different transverse phase-gradient or mirror-tilt settings, different programmed spatial-light-modulator or metasurface patterns, or different motion or time-evolution states. The number of encoded states is not limited to three and may be two, or may be four or more, including an M-ary alphabet, and the states may be discrete or, in some embodiments, continuously varied.

A region covering substantially the full pattern exhibited a between-state variation of less than approximately one percent across the three states, confirming that the total integrated intensity was substantially unchanged between states. In contrast, localized fixed regions of interest placed at fringe-boundary locations exhibited between-state variations of approximately eight percent to fourteen percent for the same states, and an independent automated subdivision of the pattern identified candidate regions varying by up to approximately sixteen to seventeen percent. This confirmed that the state-dependent information resided in the spatial redistribution of intensity rather than in the total integrated intensity.

In a repeated-acquisition test, the spiral-phase element was set to each state in turn and held fixed while a plurality of frames were captured under fixed detector exposure and gain. For a single fixed region of interest, the within-state frame-to-frame variation was small (coefficient of variation of order a few tenths of one percent), and a noise-normalized between-state separation statistic of the form described above evaluated to approximately D=8.7, well above a threshold of approximately three, demonstrating that the three states were separated far beyond the frame-to-frame noise.

A blind nearest-centroid mapping of individual frames using a single fixed region of interest recovered the encoded state of individual frames at an accuracy substantially above the chance level for three states. Extending the spatial response vector to four fixed regions, and standardizing the region intensity measures prior to a distance-based mapping, increased the recovery accuracy to approximately ninety-nine percent over ninety frames, with weak individual regions resolved by complementary stronger regions as described above. In a held-out test, a pre-committed sequence of thirty symbols over the three states was recovered using reference vectors fixed in advance of acquisition and a per-symbol majority decision over a plurality of frames per symbol, reaching a symbol accuracy of approximately ninety-three percent and a derived bit-error rate of approximately five percent for one set of state separations and region geometry.

This example is illustrative and does not limit the claims. The particular wavelength, the number and angular separation of the encoded states, the number and placement of the fixed regions of interest, the particular separation statistic and thresholds, the particular classifier, and the particular detector are examples; other values, geometries, and implementations within the scope of the claims may be used, including the commercial receiver embodiments described above.

What is claimed is:

1. A method of recovering information encoded in a structured optical pattern, the method comprising:
receiving, at an optical detector, a structured optical pattern having a total integrated intensity and a spatial intensity distribution configurable into two or more encoded states;
sampling the spatial intensity distribution at a plurality of fixed regions of interest, each fixed region of interest subtending a sub-portion of the structured optical pattern smaller than a full area thereof and at least two of the fixed regions of interest being disposed at different locations within the spatial intensity distribution, at least a subset of the fixed regions of interest having been selected or validated by both (i) a noise-normalized between-state separation statistic, determined over a plurality of repeated acquisitions per encoded state, exceeding a predetermined separation threshold, and (ii) an average intensity exceeding a detector noise floor by a predetermined margin;
deriving, for each fixed region of interest, a respective region intensity measure;
forming a spatial response vector from the respective region intensity measures; and
mapping the spatial response vector to an encoded information symbol selected from the two or more encoded states;
wherein the encoded information symbol is recovered from a spatial redistribution of intensity among the plurality of fixed regions of interest that occurs between the encoded states while the total integrated intensity remains substantially unchanged between those encoded states.

2. A method of recovering information encoded in a spiral-geometric structured optical interference pattern, the method comprising:
receiving, at an optical detector, a structured optical interference pattern produced by spiral-phase modulation of coherent electromagnetic radiation, the interference pattern having a spiral-geometric intensity distribution comprising at least one spiral, curved, azimuthal, radial, or vortex-related intensity feature and having a total integrated intensity;
defining a plurality of fixed regions of interest at different spatial locations relative to the spiral-geometric intensity distribution, at least a subset of the fixed regions of interest having been selected or validated by both a noise-normalized between-state separation criterion determined over a plurality of repeated acquisitions per encoded state and a detector-noise-floor criterion;
sampling the plurality of fixed regions of interest to derive respective region intensity measures and forming a spatial response vector therefrom; and
mapping the spatial response vector to an encoded information symbol selected from a set of two or more encoded spiral-geometric states;
wherein the encoded information symbol is recovered from a redistribution, displacement, rotation, curvature change, or relative intensity change of the spiral-geometric intensity distribution among the fixed regions of interest while the total integrated intensity remains substantially unchanged between the encoded spiral-geometric states.

3. The method of claim 2, wherein the plurality of fixed regions of interest are positioned or registered relative to a spiral-geometric reference feature comprising at least one of a vortex core, a phase-singularity location, a spiral center, a fringe-defect location, a radial axis, an azimuthal sector boundary, or a curved fringe boundary of the spiral-geometric intensity distribution, and wherein at least one of the fixed regions of interest is detector-fixed, pattern-registered, tracked, moving, or adaptively updated while remaining registered to the spiral-geometric reference feature such that its region intensity measure remains comparable across the encoded spiral-geometric states.

4. The method of claim 2, wherein the spiral-phase modulation is imposed upon the coherent electromagnetic radiation more than once per round trip by a spiral-phase optical element traversed on an outgoing pass and again on a returning pass in a reflective interferometric geometry, and wherein the encoded spiral-geometric states do not require purity of an orbital-angular-momentum mode.

5. The method of claim 2, wherein at least a portion of the fixed regions of interest comprise angular sectors, radial sectors, wedge regions, annular regions, or quadrant regions arranged about a spiral center or vortex-related reference point of the spiral-geometric intensity distribution.

6. The method of claim 1, wherein at least one fixed region of interest has a width comparable to or smaller than a displacement of an intensity feature of the structured optical pattern between encoded states, such that movement of the intensity feature between the encoded states produces a change in the respective region intensity measure greater than a change produced, by the same movement, in a region whose width is large relative to said displacement.

7. The method of claim 1, wherein the predetermined separation threshold corresponds to a between-state separation of at least approximately three times a pooled within-state standard deviation of the region intensity measure.

8. The method of claim 1, wherein the predetermined margin is at least approximately five times a standard deviation of a detector dark-signal, so that a region carrying insufficient absolute signal is excluded notwithstanding a high separation statistic.

9. The method of claim 1, wherein the plurality of fixed regions of interest comprises a first fixed region of interest responsive to a displacement or curvature change of the spatial intensity distribution between a first pair of the encoded states more strongly than between a second pair, and a second fixed region of interest responsive to a displacement or curvature change between the second pair more strongly than between the first pair, such that the spatial response vector distinguishes a pair of encoded states that is not distinguishable by either fixed region of interest alone.

10. The method of claim 1, further comprising normalizing the respective region intensity measures prior to mapping, such that the spatial response vector encodes a relative spatial distribution substantially independent of overall received power, wherein each normalized region value comprises a ratio of a corresponding region intensity measure to a sum of the region intensity measures of the plurality of fixed regions of interest.

11. The method of claim 1, wherein the fixed regions of interest are selected based on a measured separability of a communication-symbol alphabet among the encoded states, and are not selected for reconstructing a wavefront, estimating a physical surface profile, measuring a topological charge, or demultiplexing an orbital-angular-momentum mode.

12. The method of claim 1, wherein deriving the region intensity measures comprises identifying a first fixed region of interest whose region intensity measure increases between two encoded states and a second fixed region of interest whose region intensity measure decreases between the same two encoded states, and computing a differential spatial measure between the first and second fixed regions of interest normalized by a sum of their region intensity measures, the differential spatial measure comprising one or more of a left-right differential, a top-bottom differential, and a diagonal differential computed from subregions of the structured optical pattern, so as to reduce common-mode variation arising from source-power drift, detector-exposure variation, or optical alignment drift.

13. The method of claim 2, wherein recovering the encoded information symbol does not require determining an orbital-angular-momentum mode index or topological charge of the interference pattern, and wherein the encoded spiral-geometric states are represented by changes in spiral-fringe displacement, spiral-fringe curvature, vortex-core-relative intensity distribution, phase-singularity-relative intensity distribution, or azimuthal-sector intensity redistribution among the fixed regions of interest, rather than by selection of mutually orthogonal orbital-angular-momentum channel modes.

14. The method of claim 1, wherein mapping comprises assigning the spatial response vector to a nearest one of a plurality of reference vectors by nearest-centroid, template-matching, statistical, or machine-learning classification, each reference vector corresponding to a respective encoded state and determined from a calibration acquisition, and wherein a plurality of frames are acquired for each encoded symbol and combined by a majority decision.

15. The method of claim 14, wherein the reference vectors are determined from a calibration acquisition separate from a transmitted sequence of encoded symbols and fixed in advance of acquisition of the transmitted sequence, the method further comprising recovering a pre-committed transmitted sequence of encoded symbols not used to define the reference vectors.

16. The method of claim 2, wherein the encoded spiral-geometric states correspond to different values of at least one spiral parameter comprising handedness, spiral pitch, a pitch-to-radius ratio, a spiral coupling parameter, vortex orientation, phase-singularity displacement, or spiral-fringe curvature; and wherein the spiral-geometric structured optical interference pattern is generated by at least one of a vortex lens, a spiral phase plate, a vortex phase mask, a diffractive optical element, a holographic optical element, a metasurface, a spatial light modulator, an integrated photonic phase structure, a programmable phase array, a waveguide phase structure, or another wavefront-shaping element.

17. A receiver for recovering information from a structured optical pattern, the receiver comprising:
an optical detector configured to receive the structured optical pattern and to generate spatial intensity data representing a spatial intensity distribution thereof;
a region-sampling unit configured to sample the spatial intensity data at a plurality of fixed regions of interest disposed at different locations within the spatial intensity distribution and to derive a respective region intensity measure for each fixed region of interest, wherein at least one fixed region of interest is fixed relative to a detector plane or fixed relative to a reference feature of the structured optical pattern while remaining registered to the reference feature, and wherein at least a subset of the fixed regions of interest has been selected or validated by both a noise-normalized between-state separation criterion determined over a plurality of repeated acquisitions per encoded state and a detector-noise-floor criterion; and
a processing unit configured to form a spatial response vector from the respective region intensity measures and to map the spatial response vector to an encoded information symbol selected from two or more encoded states;
wherein the receiver is configured to recover the encoded information symbol from a spatial redistribution of intensity among the plurality of fixed regions of interest that occurs between the encoded states while a total integrated intensity of the structured optical pattern remains substantially unchanged between those encoded states.

18. The receiver of claim 17, wherein the optical detector comprises at least one of a camera, a CMOS image sensor, a CCD image sensor, a high-speed image sensor, an event-based sensor, a time-of-flight sensor, a depth-resolving optical sensor, a light-field or plenoptic sensor, a multi-plane detector, a volumetric detector, a quadrant photodetector, a segmented photodetector, a photodiode array, a detector array, or an integrated photonic detector, and wherein the processing unit is configured to perform region, segment, sector, layer, volume, frame-window, trajectory, or spatiotemporal sampling and symbol decoding from corresponding intensity measures, motion measures, temporal-change measures, or spatiotemporal response measures, without reconstructing a full two-dimensional image, a full three-dimensional optical field, or a full four-dimensional spatiotemporal field of the structured optical pattern.

19. The receiver of claim 17, wherein the receiver is embodied as at least one of a field-programmable gate array, a digital signal processor, a telecommunications optical receiver module, a fiber-coupled detector package, a free-space optical receiver, an integrated photonic receiver, a CMOS image sensor with an embedded processor, or a segmented or quadrant photodiode with an analog front-end deriving the region intensity measures from segment photocurrents; and wherein the processing unit comprises dedicated circuitry or a processor executing stored instructions to perform the formation of the spatial response vector and the mapping of the spatial response vector to the encoded information symbol.

20. The method of claim 1, wherein at least one fixed region of interest is fixed relative to a detector plane, occupying a same pixel or detector-segment location across encoded states, or is fixed relative to a reference feature of the structured optical pattern comprising at least one of a vortex core, a phase-singularity location, a spiral center, a fringe boundary, or a tracked intensity feature, such that the region of interest may move or be updated in detector coordinates between frames while remaining registered to the reference feature and while its region intensity measure remains comparable across the encoded states.
